(19) United States
(12) Patent Application Publication
(10) Pub. No.: US 2016/0030142 A1
(43) Pub. Date: Feb. 4, 2016

(54) Dental Crown Cementation Soft Tissue and Biologic Attachment Protective Membrane and Method of Use Thereof

(71) Applicant: Ronald Craig Haas, Commack, NY (US)

(72) Inventor: Ronald Craig Haas, Commack, NY (US)

(21) Appl. No.: 14/817,166

(22) Filed: Aug. 3, 2015

Related U.S. Application Data
(60) Provisional application No. 62/031,987, filed on Aug. 1, 2014.

(51) Int. Cl. A61C 13/07; A61C 8/00

(52) U.S. Cl. CPC A61C 13/0025; A61C 8/0048

(57) ABSTRACT

A dental crown cementation soft tissue and biologic attachment protective membrane has a dental membrane and a membrane carrier. The dental membrane is attached within the membrane carrier for easy manual manipulation. The dental membrane is used during dental crown installation to prevent dental cement from leaking out from the interior cavity of the dental crown into the gingival sulcus and surrounding soft tissue. The dental membrane is placed atop a dental abutment onto which the dental crown is to be installed. The dental crown is pressed onto the abutment over the dental membrane, causing excess cement to be extruded from the interior cavity onto the dental membrane. The dental crown then has minimal excess cement. The dental crown is then removed as well as the dental membrane, the cement on the exterior crown surface is removed, and the adequately cemented dental crown is again attached to the dental abutment.

The current application claims a priority to the U.S. Provisional Patent application Ser. No. 62/031,987 filed on Aug. 1, 2014. The current application is filed on Aug. 3, 2015, whereas Aug. 1, 2015 and Aug. 2, 2015 were on a weekend.

### FIELD OF THE INVENTION

The present invention relates generally to dental accessories, particularly in the field of dental restoration. More specifically, the present invention is a protective membrane that prevents dental cement from entering deeply into the gingival sulcus when mounting a dental crown to an abutment.

### BACKGROUND OF THE INVENTION

Dental restoration is a field of dentistry that focuses primarily on addressing tooth structural loss due to decay or other causes such as trauma. It is often necessary to replace teeth that are missing entirely, although natural teeth can be filed and otherwise prepared to accept dental crowns. Replacing a missing tooth can involve installing a threaded dental implant within the missing tooth site of the jaw. After the dental implant is in place and the surrounding tissue has fully healed, a corresponding dental abutment can be installed within the dental implant. The dental abutment serves as a mounting point for a custom-made crown. The crown, resembling a real tooth, can then be installed on the dental abutment. During the installation process, the interior of the crown is loaded with dental cement and the crown is placed on the dental abutment with firm and steady pressure. It is common for excess dental cement to extrude out of the interior of the crown during the process of mounting the crown. This is generally not an issue for the exterior gingival tissues as the excess cement can be wiped away after coming into contact with them before setting and hardening. Excess cement that pools on the exterior gingival tissue is generally easily removable after hardening as well. However, it is possible for the excess cement to enter the gingival sulcus surrounding the abutment(s). If undetected and left in place after hardening, this can result in complications such as infection, irritation, and loss of the soft and hard tissues around dental implants. If unaddressed, diseases around the dental implant can jeopardize the long-term health and survival of the implant. Excess cement entering the gingival sulcus can be an issue when mounting dental crowns to prepared natural teeth as well. The issue of excess cement entering the gingival sulcus can be minimized by recreating the patient's dental arch by duplicating the individual abutments. This allows the dental crowns filled with cement to be placed onto the recreated abutments outside of the mouth to remove excess unset cement. Removal of the excess cement that flows out, results in a thin coating layer of cement remaining within the dental crowns. The dental crowns are then removed from the recreated dental arch resulting in a thin coating layer of cement remaining inside. The crowns are then installed on the corresponding abutment within the patient's mouth with minimal excess cement. However, recreating a dental arch solely for addressing the issue of excess cement is inconvenient, time-consuming, and costly. The present invention seeks to provide a convenient, straightforward, and reasonably costing solution that addresses the aforementioned issues without hindering dental restoration processes.

The object of the present invention is to prevent excess dental crown cement from entering deeply into the gingival sulcus during the dental crown mounting process. The present invention eliminates the need for a fully recreated dental arch outside of a patient's mouth for the purpose of removing excess cement. The protective membrane is placed over the corresponding dental abutment(s) prior to mounting the dental crown(s). The protective membrane is placed in a manner such that the gingival sulcus and immediate surrounding soft tissues are fully covered. Cement is loaded into the dental crown(s) in the normal manner and the dental crown(s) may then be initially installed on the corresponding abutments. The protective membrane within the interior of the dental crowns conforms to the dental abutments as the dental crowns are mounted. This allows excess cement to exit the dental crown(s) and onto the protective membrane and exterior crown surfaces, initially avoiding the gingival sulcus entirely. The crown(s) and membrane covered with all excess cement are then removed from the mouth. The membrane partially covered with excess cement is then removed from the crown(s). After excess unset cement has been removed from the exterior surfaces, only a thin layer of cement remains in the interior of the crown(s). The dental crown(s) may be remounted to the dental abutment(s), now with only a thin coating layer of cement inside resulting in minimal excess.

### BRIEF DESCRIPTION OF THE DRAWINGS

FIG. 1 is a perspective view of the dental membrane.

FIG. 2 is a top view of the dental membrane.

FIG. 3 is a perspective view of the dental membrane with an attached membrane carrier.

FIG. 4 is top view of the dental membrane with an attached membrane carrier.

FIG. 5 is a perspective view of the dental membrane positioned over an example dental arch with dental abutments.

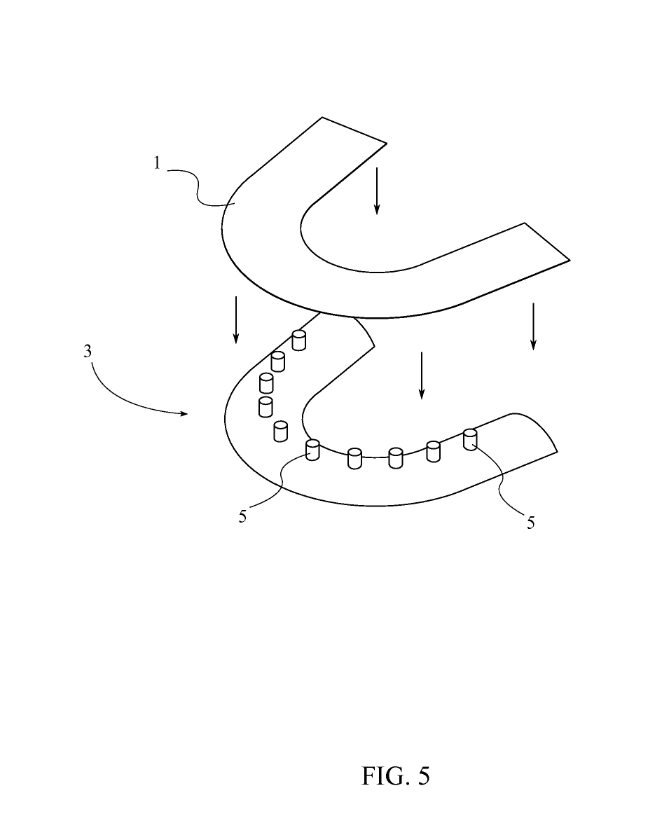

FIG. 6 is a top internal view of the dental membrane positioned over an example dental arch with dental abutments.

FIG. 7 is a perspective view of the dental membrane placed over an example dental arch with dental abutments.

FIG. 8 is a perspective internal view of the dental membrane placed over an example dental arch with dental abutments.

FIG. 9 is a top internal view of the dental membrane placed over an example dental arch with dental abutments.

FIG. 10 is a perspective view of the dental membrane placed over an example dental arch with dental abutments and a tooth positioned over a covered dental abutment and with dental cement in the interior cavity of the dental crown.

FIG. 11 is a perspective view of a dental crown installed on a covered dental abutment on an example dental arch with excess dental cement having been extruded onto the dental membrane.

FIG. 12 is a side internal view of a dental crown installed on a single covered dental abutment showing dental cement between the interior of dental crown and the protective membrane as well as excess dental cement being extruded onto the dental membrane surrounding the dental crown.

FIG. 13 is a perspective internal view of an example set of dental crowns installed on a set of covered dental abutments on an example dental arch.

FIG. 14 is a flowchart describing the method of using the dental membrane of the present invention.

FIG. 15 is a general overview of the method of the present invention

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced without the implementation of some features as they are described. It should be understood that some details have not been described in detail in order to not unnecessarily obscure focus of the invention.

The present invention is a protective dental membrane for use in dental restoration procedures, particularly in dental crown preparation and installation. The present invention is a protective dental membrane that is designed to shield the gingival tissues and especially the gingival sulcus from excess cement extruding from the interior of a dental crown during mounting to an abutment.

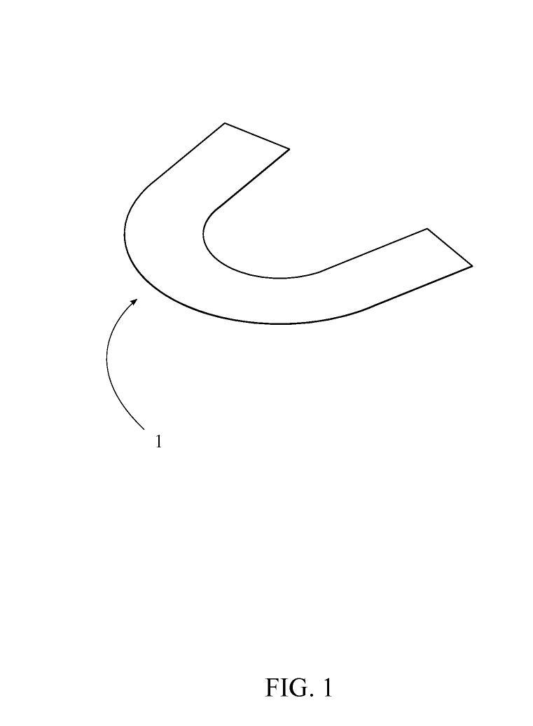

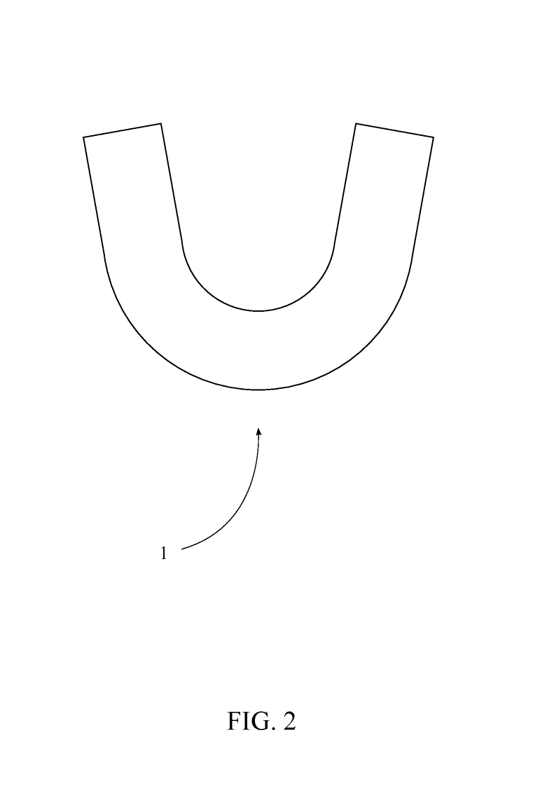

Referring to FIGS. 1 and 2, the preferred embodiment of the dental membrane 1 of the present invention is a U-shaped membrane that is sufficiently large to cover an entire dental arch 3 of dental implants and the corresponding dental abutments 5. The U-shaped protective membrane is not limited with respect to specific material. However, in the preferred embodiment of the present invention, the protective membrane is composed of an ultrathin, flexible, non-sticky, and hypoallergenic material that is available in a wide variety of shapes and sizes. The present invention may also be utilized to mount dental crowns encompassing any number of prepared natural teeth up to a full dental arch 3. As a result, the protective membrane is available in a variety of sizes to accommodate a variety of user needs.

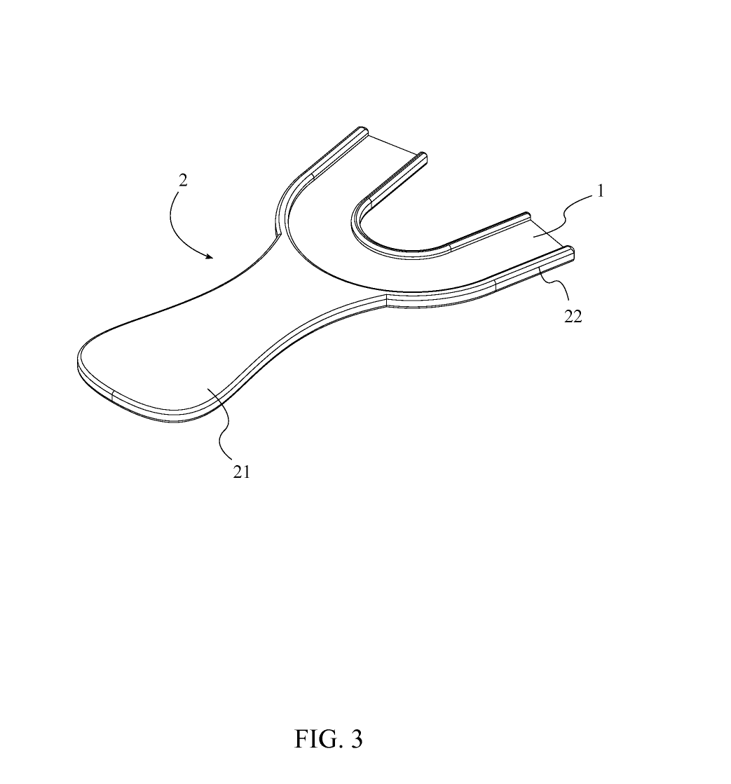

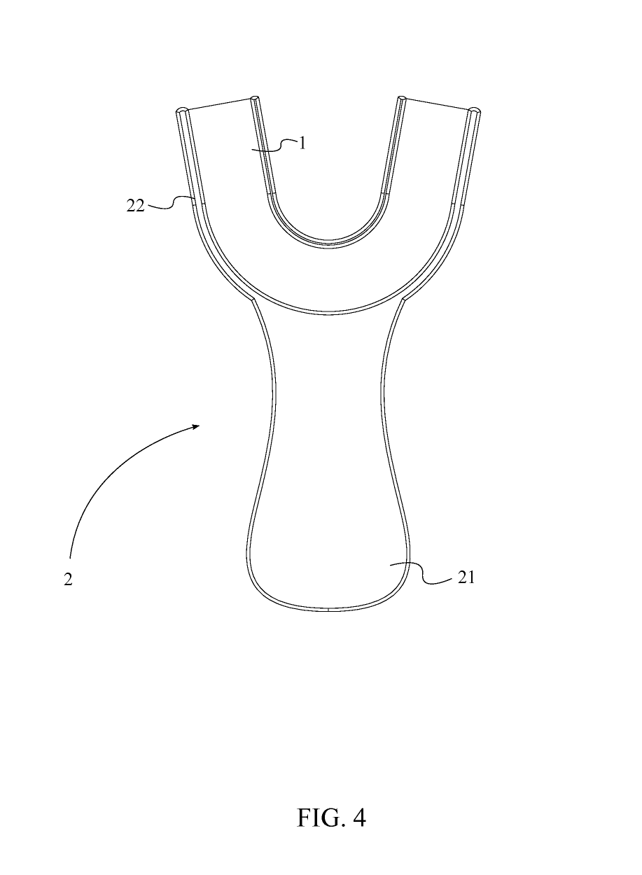

Referring to FIGS. 3 and 4, the preferred embodiment of the present invention comprises a thin, flexible dental membrane 1 and a membrane carrier 2 comprising a handle portion 21 and a membrane holder portion 22. The handle portion 21 and the membrane holder are connected to each other. In the preferred embodiment, the handle portion 21 is substantially flat, though the handle portion 21 may take any physical form that allows a user to conveniently and easily handle the apparatus of the present invention in order to manipulate the dental membrane 1 into position within the mouth of a dental patient. The membrane holder portion 22 serves to support the dental membrane 1 for manual manipulation. The membrane holder portion 22 is intended solely to support and carry the dental membrane 1 and so is required solely to comprise enough structure to surround the perimeter of the dental membrane 1. Therefore, the dental membrane 1 is internally and perimetrically connected to the membrane holder portion 22.

The dental membrane 1 is the primary focus of the present invention. In the preferred embodiment of the present invention, the dental membrane 1 is generally u-shaped, resembling a dental arch 3, in order to be able to cover an entire dental arch 3 of a dental patient, as well as the gingival sulcus, biologic attachment and immediate surrounding soft tissues during the dental crown 4 installation process. In alternate embodiments, the dental membrane 1, and thus the membrane holder portion 22, may comprise less than a full dental arch shape, and be shaped to accommodate only a portion of a dental arch 3. However, the fundamental requirement for the shape of the dental membrane 1 is to be able to cover at least one tooth of a dental arch 3. In a dental crown 4 installation procedure, it may be necessary to operate on a range from only one tooth to the entire dental arch 3.

It is important in the preferred embodiment of the present invention for the material of the dental membrane 1 to have certain specified qualities. The protective membrane is not necessarily limited with respect to specific material, so long as certain requirements are met. Due to the nature of the applications of the protective membrane, it is important that the dental membrane 1 demonstrates several key material properties including, but not limited to: high level of thinness and flexibility, non-stickiness, hypoallergenic, and available in a wide variety of shapes and sizes.

The dental membrane 1 should be thin enough so that space between the dental membrane 1 and the interior cavity 41 of the dental crown 4 is minimized while simultaneously providing enough space for sufficient dental cement to remain inside the dental crown 4 to adequately cement the dental crown 4 onto the dental abutment 5. Generally, it is desirable for the dental membrane 1 to be as thin as possible. More particularly, the dental membrane 1 should have a thickness of 50 microns or less, with 50 microns being the upper desirable limit for the thickness of the dental membrane 1.

Additionally, the dental membrane 1 needs to be impermeable to dental cement, since protecting the gingival sulcus and surrounding tissues of a dental patient is the primary purpose of the present invention. Dental cement should not easily adhere to the dental membrane 1, and the material of the dental membrane 1 should be a hypoallergenic material to avoid causing allergic reactions when placed into contact with gingival material. In one preferred embodiment of the present invention, the material of the dental membrane 1 is polytetrafluoroethylene, though in alternate embodiments any other materials may be utilized which fulfill the aforementioned requirements.

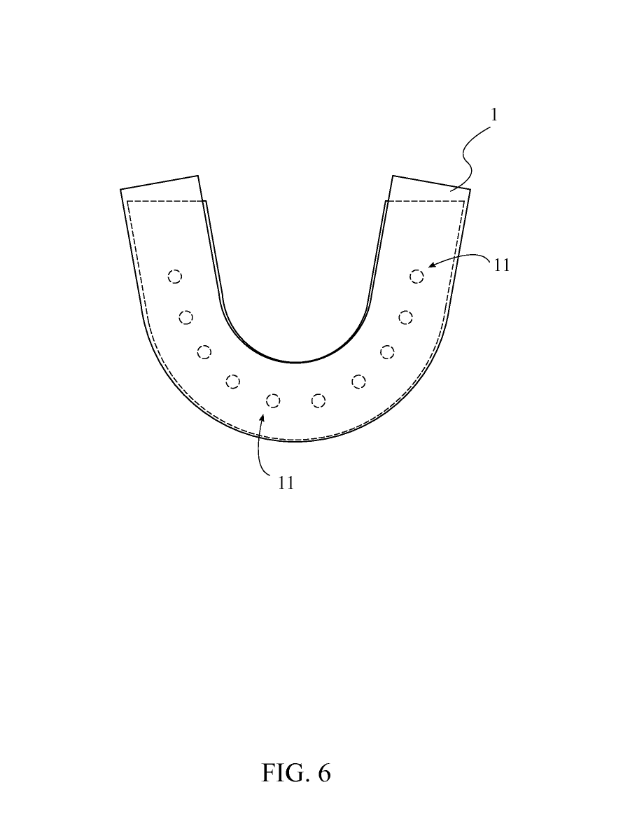

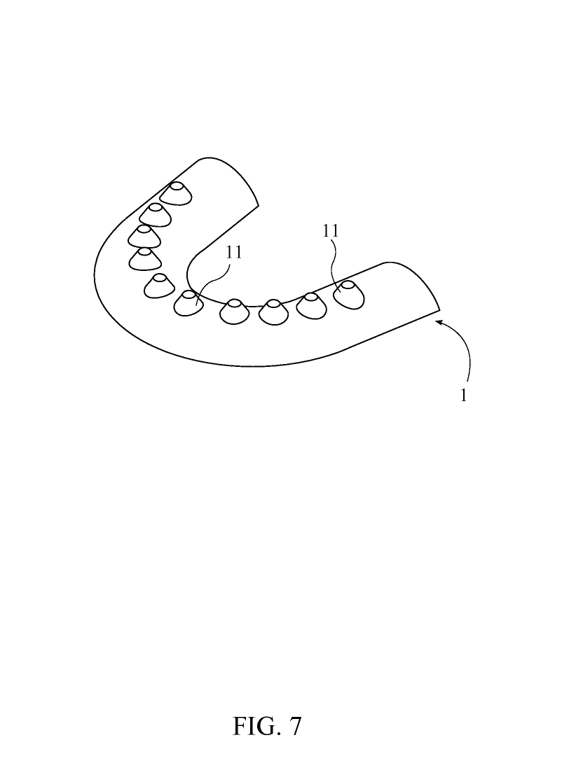

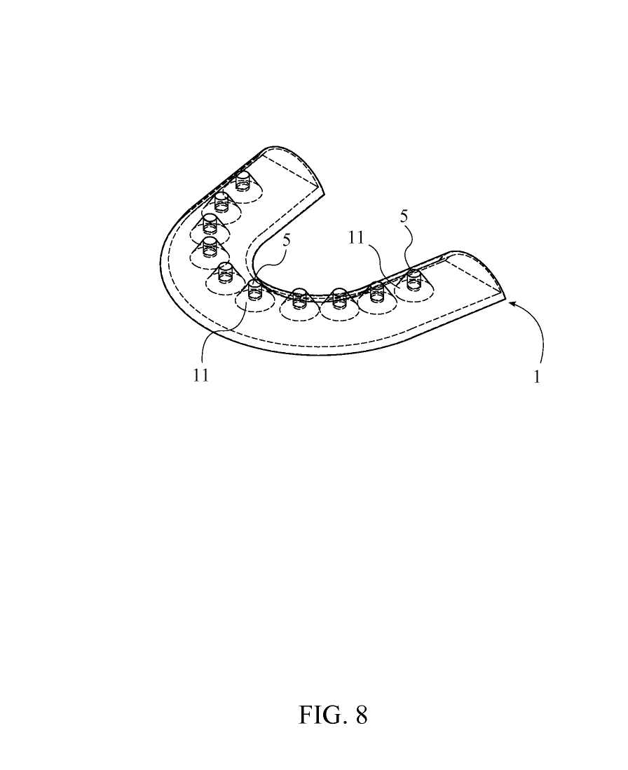

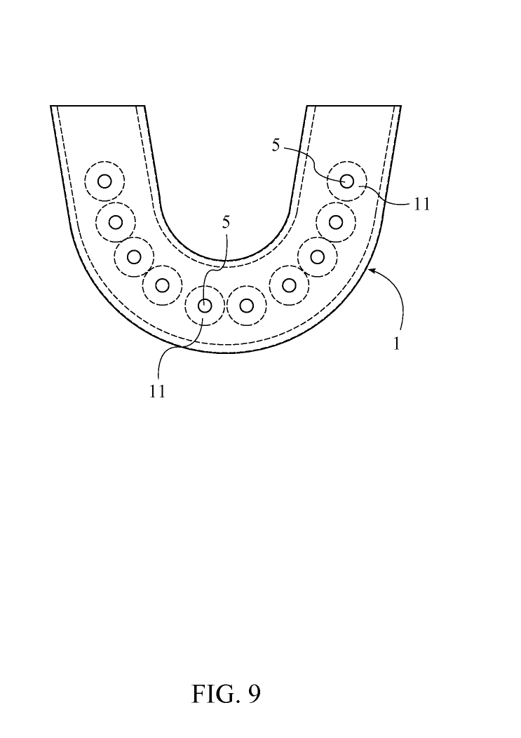

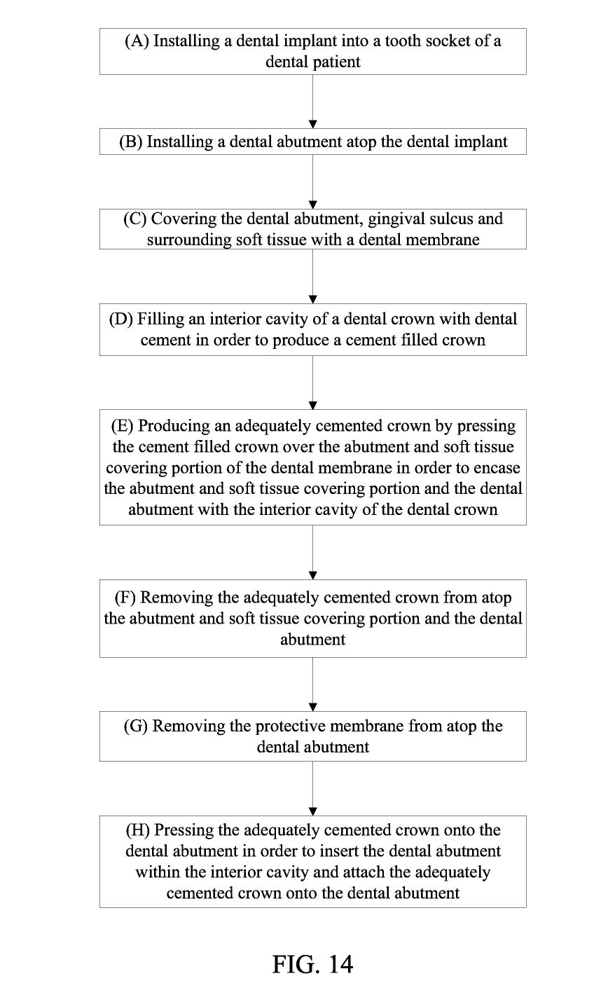

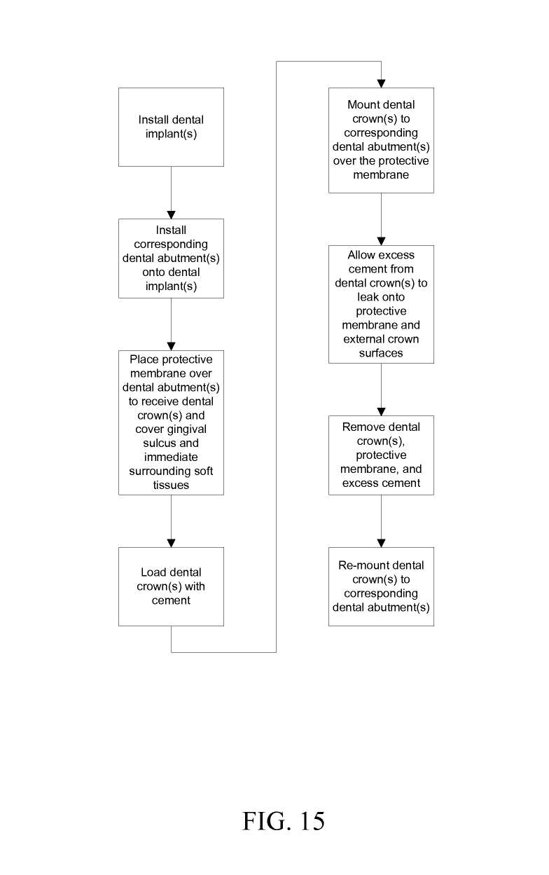

Referring to FIGS. 14-15, the method of using the dental membrane 1 in the present invention is as follows. First, a dental implant is installed into a tooth socket of a dental patient within the dental patient's dental cavity. A dental abutment 5 is then installed atop the dental implant. The dental abutment 5, gingival sulcus and surrounding soft tissue is covered with the dental membrane 1, as shown in FIGS. 6-9. The gingival sulcus is positioned adjacent to the tooth socket, and the surrounding soft tissue is positioned adjacent to the gingival sulcus around the tooth socket. An abutment and soft tissue covering portion 11 of the dental membrane 1 covers and conforms to the dental abutment 5. The abutment and soft tissue covering portion 11 is simply whatever physical region of the dental membrane 1 covers and physically conforms to the dental abutment 5 and surrounding soft tissue and is solely introduced for reference.

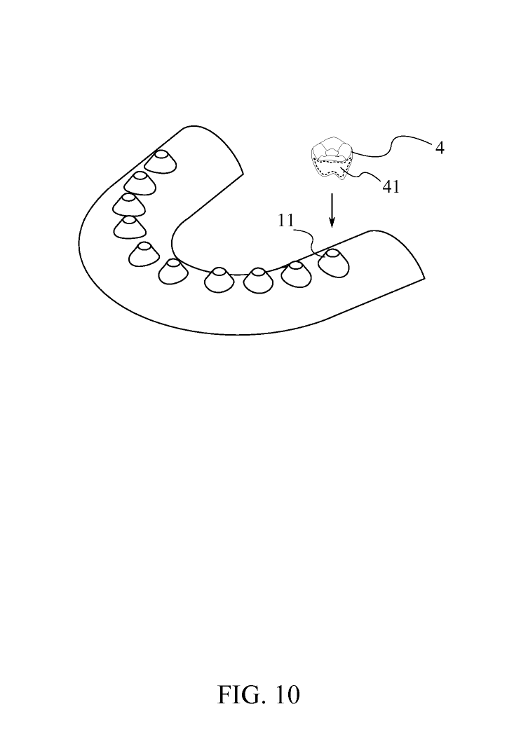

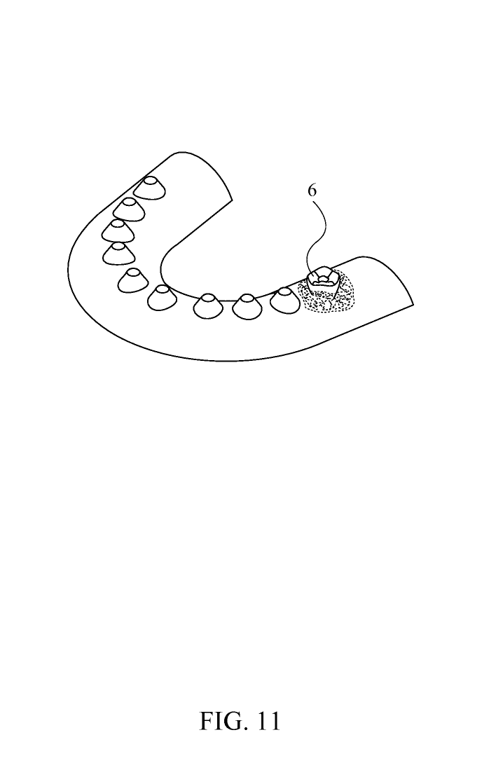

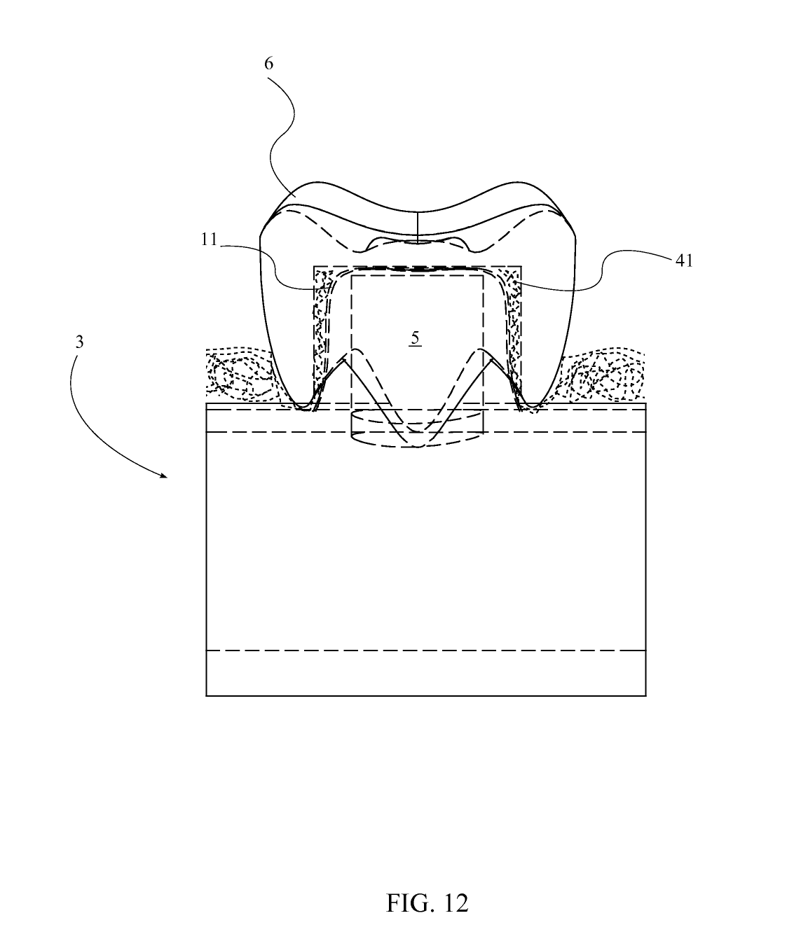

An interior cavity 41 of a dental crown 4 is then generously filled with dental cement in order to produce a generously cement filled crown. Referring to FIGS. 10-12, an adequately cemented crown 6 with minimal excess cement is then produced by pressing the cement filled crown over the abutment and soft tissue covering portion 11 of the dental membrane 1 in order to encase the abutment and soft tissue covering portion 11 and underlying dental abutment 5 with the interior cavity 41 of the dental crown 4. In doing so, excess dental cement is extruded from within the interior cavity 41 onto the dental membrane 1 by pressing the interior cavity 41 of generously cement filled crown over the abutment and soft tissue covering portion 11 and the dental abutment 5, thereby forcing the physical form occupied by the dental abutment 5 and dental membrane 1 to displace dental cement from within the interior cavity 41 of the dental crown 4.

The dental crown, now an adequately cemented crown 6 by removing excess dental cement from the interior cavity 41 by displacing the excess cement with the dental abutment 5, is then removed from atop the abutment and soft tissue covering portion 11 and the dental abutment 5. The dental membrane 1 is also removed from atop the dental abutment 5, and the excess cement is removed from the exterior of the now adequately cemented crown 6. The interior cavity 41 of the dental crown 4 retains a thin coating layer of dental cement, thus being adequately cemented. Finally, the adequately cemented crown 6 is pressed onto the dental abutment 5 in a similar manner as before but with the difference of the dental membrane 1 being removed. Thus the dental abutment 5 is inserted within the interior cavity 41, and the adequate amount of dental cement still present serves to securely attach the adequately cemented crown 6 onto the dental abutment 5 while producing minimal extruded excess dental cement. The thin coating layer of cement ensures that the dental crowns are secured to the dental abutments 5 with minimal excess cement.

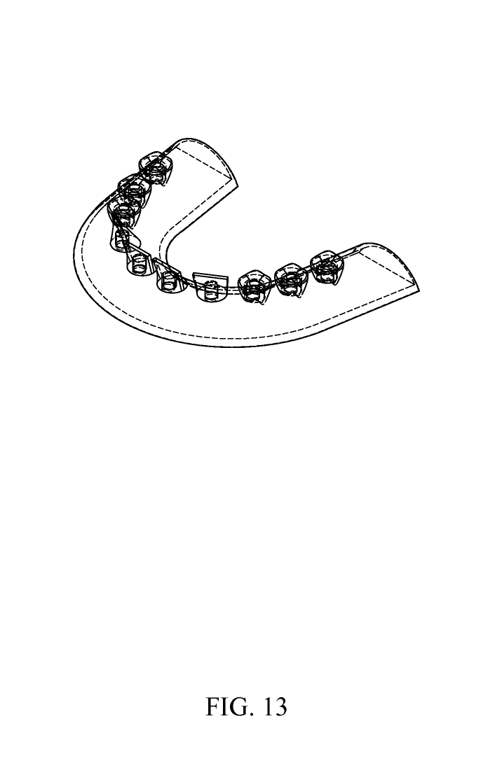

The previously discussed method of use of the dental membrane 1 relates generally to dental crowns that are secured to implant abutments that are replacing missing teeth. However, the dental membrane 1 has applications in dental restoration procedures in which dental crowns are mounted onto prepared natural teeth as well. A natural tooth is prepared for crowning by filing or otherwise removing portions of the tooth in preparation for accepting the crown. As such, the prepared natural tooth serves the role of an “abutment”. A dental crown is mounted with cement to the prepared natural tooth after preparation. The dental membrane 1 of the present invention may be placed over prepared natural teeth in order to allow excess cement to exit from the dental crown while protecting the gingival sulcus. In the context of prepared natural teeth, the method of use of the protective membrane is the same as that in the context of dental implant abutments. The aforementioned process may also be performed for the entire dental arch, as shown in FIG. 13.

Without the dental membrane 1, excess cement displaced by the dental abutment 5 being forced within the interior cavity 41 will spill out onto the gingival sulcus and surrounding tissue upon installation. With the present invention, the excess cement is captured by the dental membrane 1 and is able to be removed without the risk of irritation, infection, mess, and other inconvenience. In review, a generously cement filled crown is seated onto the dental membrane covered abutment resulting in all but a minimal amount of cement remaining inside the crown when removed initially. After cleaning the exterior of the crown and removing the membrane, the minimally cement filled crown can be reseated and only then can produce an adequately cemented crown with minimal excess.

Although the invention has been explained in relation to its preferred embodiment, it is to be understood that many other possible modifications and variations can be made without departing from the spirit and scope of the invention as hereinafter claimed.

What is claimed is:

1. A dental crown cementation soft tissue and biologic attachment protective membrane comprises:
a dental membrane; and
the dental membrane being thin and flexible.

2. The invention as claimed in claim 1 comprises:
a membrane carrier comprising a handle portion and a membrane holder portion;
the handle portion and the membrane holder portion being connected to each other; and
the dental membrane being internally and perimetrically connected to the membrane holder portion.

3. The invention as claimed in claim 1 comprises:
the dental membrane being u-shaped.

4. The invention as claimed in claim 1 comprises:
the dental membrane being shaped to resemble a dental arch.

5. The invention as claimed in claim 1 comprises:
the dental membrane having a thickness equal to or less than 50 microns.

6. The invention as claimed in claim 1 comprises:
the dental membrane being impermeable to dental cement.

7. The invention as claimed in claim 1 comprises:
the dental membrane being made of a hypoallergenic material.

8. The invention as claimed in claim 1 comprises:
the dental membrane being made of polytetrafluoroethylene.

9. A method of using a dental crown cementation soft tissue and biologic attachment protective membrane comprises the steps of:
installing a dental implant into a tooth socket of a dental patient;
installing a dental abutment atop the dental implant;
covering the dental abutment, a gingival sulcus and surrounding soft tissue with a dental membrane, wherein the gingival sulcus is positioned adjacent to the dental abutment, and wherein the surrounding soft tissue is positioned around to the gingival sulcus opposite the tooth socket, and wherein an abutment and soft tissue covering portion of the dental membrane covers the dental abutment and the surrounding soft tissues;
filling an interior cavity of a dental crown with dental cement in order to produce a cement filled crown;
producing an adequately cemented crown by pressing the cement filled crown over the abutment and soft tissue covering portion of the dental membrane in order to encase the abutment and soft tissue covering portion and the dental abutment with the interior cavity of the dental crown, wherein excess dental cement is extruded from within the interior cavity onto the dental membrane by pressing the cement filled crown over the abutment and soft tissue covering portion and the dental abutment;
removing the adequately cemented crown from atop the abutment and soft tissue covering portion and the dental abutment;
removing the protective membrane from atop the dental abutment;
removing the excess cement from the exterior of the adequately cemented crown; and
pressing the adequately cemented crown onto the dental abutment in order to insert the dental abutment within the interior cavity and attach the adequately cemented crown onto the dental abutment.
